(19) United States
(12) Patent Application Publication
(10) Pub. No.: US 2013/0035935 A1
(43) Pub. Date: Feb. 7, 2013

(54) DEVICE AND METHOD FOR DETERMINING SEPARATION CRITERION OF SOUND SOURCE, AND APPARATUS AND METHOD FOR SEPARATING SOUND SOURCE

(71) Applicants: Young Ik KIM, Daejeon (KR); Hoon Young Cho, Daejeon (KR); Sang Hun Kim, Daejeon (KR)

(72) Inventors: Young Ik KIM, Daejeon (KR); Hoon Young Cho, Daejeon (KR); Sang Hun Kim, Daejeon (KR)

(73) Assignee: Electronics and Telecommunications Research Institute, Daejeon (KR)

(21) Appl. No.: 13/461,214

(22) Filed: May 1, 2012

(30) Foreign Application Priority Data
Aug. 1, 2011 (KR) 10-2011-0076622

(51) Int. Cl. G10L 15/20

(52) U.S. Cl. 704/233; 704/E15.039

(57) ABSTRACT

The present invention allows a man to recognize a location of a sound source in a three-dimensional space using two ears and applies a method of separating a sound source in a certain orientation to improve the performance of an application technology using a speech in a noisy environment. The present invention acquires a speech signal using two sensors and determines an orientation angle of a sound source in a zero-crossing point step with respect to a frequency separated signal with a band pass filter bank. An object of the present invention is to obtain excellent sound source orientation detection and division performance which is difficult to be obtained in an existing crossing correlation method calculated in units of time frames in a noisy environment with a plurality of sound sources.

### CROSS-REFERENCE TO RELATED APPLICATIONS

This application claims priority to and the benefit of Korean Patent Application No. 10-2011-0076622 filed in the Korean Intellectual Property Office on Aug. 1, 2011, the entire contents of which are incorporated herein by criterion.

### TECHNICAL FIELD

The present invention relates to a device and a method for determining a criterion for separating a sound source from a speech signal and separating the sound source from the speech signal based on the determined criterion, and more particularly, to a device and a method for determining a criterion for separating a sound source from a speech signal based on zero-crossing and separating the sound source from the speech signal based on the determined criterion.

### BACKGROUND ART

Because the performance of an application technology using speech such as speech section determination, speaker recognition, and speech recognition is significantly deteriorated in a noisy environment, the performance of an application technology has a big difference from the human cognitive performance. So as to solve such a difference, there has been an attempt to distinctively recognize a sound source by a human auditory system.

Yilmaz and Rickard have suggested a DUET method of separating a sound source from a time-frequency domain in the paper of [Blind separation of speech mixtures via time-frequency masking, IEEE Transaction on Signal Processing, 52(7), pp. 1830-1847, 2004]. The suggested method separates the sound source from a two dimensional space on the assumption that a plurality of sound sources do not overlap in a time-frequency domain. However, the suggested method is similar to a cross correlation method and has a difficulty in searching an orientation of a sound source and in separating the sound source when a plurality of sound sources overlap each other in a time-frequency domain.

Roman, Wang, Brown, and et al. have suggested a method of imitating a human spatial auditory system in the paper of [Speech segregation based on sound localization, Journal of the Acoustical Society of America, 114(4), pp. 2236-2252, 2003]. The suggested method is a method of previously learning an ideal boundary value for separating a target sound source and an interference noise to maximize a sound source separation performance. However, it is inconvenient to previously learn an orientation of a sound source using this suggested method. Because the suggested method depends on a learning result, when there are a plurality of sound sources, the performance is remarkably deteriorated.

### SUMMARY OF THE INVENTION

The present invention has been made in an effort to provide a device and a method for determining a criterion for separating a sound source using a signal-to-noise ratio and an energy value obtained from an input signal based on a zero-crossing point.

Further, the present invention has been made in an effort to provide an apparatus and a method for separating a target sound source and an interference noise from an input signal based on the criterion.

An exemplary embodiment of the present invention provides a device for determining a separation criterion of a sound source, the device including: a histogram generator generating a histogram associated with a directionality of a sound source included in an input signal based on a signal-to-noise ratio obtained from the input signal or an energy value of the input signal; a noise region detector detecting a noise region from the input signal using a highest value in the generated histogram as a region value of a target sound source; and a sound source separation criterion determinator determining a boundary value between the target sound source and the detected noise region as a criterion value for separating the sound source.

The noise region detector may detect the noise region based on at least one next highest value located at a left side or a right side of the highest value. The noise region detector may include: a next highest value determining unit determining whether the next highest value not less than a multiplication value of a threshold and the highest value and not greater than an absolute value of the highest value is located at the left side or the right side thereof; and a detecting unit detecting the noise region based on the next highest value when the next highest value is located, and detecting the noise region in consideration of an directionality of the target sound source based on the highest value when the next highest value is not located.

The sound source separation criterion determinator may determine an intermediated value of the highest value and the next highest value as the criterion value.

The histogram generator may include: a speech signal acquiring unit acquiring a speech signal as the input signal; a frequency separation signal extracting unit frequency-separating the acquired speech signal to extract channel signals; a signal-to-noise ratio estimating unit estimating the signal-to-noise ratio from the extracted channel signals; and a horizontal angle histogram generating unit generating a horizontal angle histogram as the histogram and using a signal-to-noise ratio estimated when generating the horizontal angle histogram. The signal-to-noise ratio estimating unit may estimate the signal-to-noise ratio using an Inter-aural Time Delay (ITD) obtained in a zero-crossing point of the extracted channel signal, and the histogram generator includes a signal energy calculating unit calculating the energy value to be used for generating the histogram using an Inter-aural Intensity Difference (IID) acquired in at least one zero-crossing section adjacent to the zero-crossing point.

The histogram generator may generate the histogram using a multiplication value of the signal-to-noise ratio and the energy value as a weight value.

Another exemplary embodiment of the present invention provides a method for determining a separation criterion of a sound source, the method including: generating a histogram associated with an directionality of a sound source included in an input signal based on a signal-to-noise ratio obtained from the input signal or an energy value of the input signal; detecting a noise region from the input signal using a highest value in the generated histogram as a region value of a target sound source; and determining a boundary value between the target sound source and the detected noise region as a criterion value for separating the sound source.

The detecting of a noise region may include detecting the noise region based on at least one next highest value located at a left side or a right side of the highest value. The detecting of a noise region may include: determining whether the next highest value not less than a multiplication value of a threshold and the highest value and not greater than an absolute value of the highest value is located at the left side or the right side; and detecting the noise region based on the next highest value when the next highest value is located, and detecting the noise region in consideration of an directionality of the target sound source based on the highest value when the next highest value is not located.

The determining of a boundary value between the target sound source and the detected noise region may determine an intermediate value of the highest value and the next highest value as the criterion value.

The generating of a histogram may include: acquiring a speech signal as the input signal; frequency-separating the acquired speech signal to extract channel signals; estimating the signal-to-noise ratio from the extracted channel signals; and generating a horizontal angle histogram as the histogram and using a signal-to-noise ratio estimated when generating the horizontal angle histogram. The estimating of the signal-to-noise ratio may include estimating the signal-to-noise ratio using an Inter-aural Time Delay (ITD) obtained in a zero-crossing point of the extracted channel signal, and the generating of the histogram may further include calculating the energy value to be used for generating the histogram using an Inter-aural Intensity Difference (IID) acquired in at least one zero-crossing section adjacent to the zero-crossing point.

The generating of a histogram may generate the histogram using a multiplication value of the signal-to-noise ratio and the energy value as a weight value.

Yet another exemplary embodiment of the present invention provides an apparatus for separating a sound source, the apparatus including: a sound source orientation detector detecting an orientation of a sound source included in an input signal using a signal-to-noise ratio associated with an Inter-aural Time Delay (ITD) of the input signal or an energy value associated with an Inter-aural Intensity Difference (IID) of the input signal; a histogram generator generating a histogram associated with orientation of the sound source based on the SNR or the energy value; a noise region detector detecting a noise region from an input signal using a highest value in the generated histogram as a region value of a target sound source; a sound source separation criterion determinator determining a boundary value between the target sound source and the detected noise region as a criterion value for separating the sound source; and a sound source separator separating the input signal into the target sound source and the noise based on the criterion value.

The sound source separator may include: a signal energy allotting unit allotting an energy value associated with a highest value in a corresponding region for each division region divided from the input signal; an energy ratio calculating unit calculating an allotted energy ratio between the target sound source and the detected noise region based on the criterion value; a noise removing unit removing the noise from the input signal based on the allotted energy ratio; and a target sound source extracting unit extracting the target sound source from the input signal from which the noise is removed.

The sound source orientation detector may include: a channel signal calculating unit calculating the ITD and the IID for each channel signal obtained by frequency-separating the input signal; a horizontal angle transferring unit transferring the ITD and the IID obtained through the calculation into horizontal angle values, respectively; and a horizontal angle based orientation detecting unit detecting an orientation of the sound source by one horizontal angle acquired when a difference between the two transferred horizontal angles has the smallest value.

Still another exemplary embodiment of the present invention provides a method for separating a sound source, the method including: detecting an orientation of a sound source included in an input signal using a signal-to-noise ratio associated with an Inter-aural Time Delay (ITD) of the input signal or an energy value associated with an Inter-aural Intensity Difference (IID) of the input signal; generating a histogram associated with orientation of the sound source based on the SNR or the energy value; detecting a noise region from an input signal using a highest value in the generated histogram as a region value of a target sound source; determining a boundary value between the target sound source and the detected noise region as a criterion value for separating the sound source; and separating the input signal into the target sound source and the noise based on the criterion value.

The separating of the input signal may include: allotting an energy value associated with a highest value in a corresponding region for each division region divided from the input signal; calculating an allotted energy ratio between the target sound source and the detected noise region based on the criterion value; removing the noise from the input signal based on the allotted energy ratio; and extracting the target sound source from the input signal from which the noise is removed.

The detecting of an orientation of a sound source may include: calculating the ITD and the IID for each channel signal obtained by frequency-separating the input signal; transferring the ITD and the IID obtained through the calculation into horizontal angle values, respectively; and detecting an orientation of the sound source by one horizontal angle acquired when a difference between the two transferred horizontal angles has the smallest value.

According to exemplary embodiments of the present invention, it is possible to determine a criterion for separating a sound source based on an SNR and an energy value obtained from an input signal based on a zero-crossing point and separate a target sound source and an interference noise from the input signal based on the criterion, which leads to following effects. First, because ITD and an IID in a zero-crossing point are used, it is possible to robustly detect an orientation of a sound source in a noisy environment. Second, it is possible to exactly calculate an SNR through robust detection of an orientation of the sound source. Although the orientation of the sound source is changed, it is possible to flexibly determine the criterion for separating a sound source. Thirdly, it is possible to detect the orientation of the sound source regardless of a frequency channel. It is possible to improve the separating performance of a sound source in a situation in which there are a plurality of sound sources.

The foregoing summary is illustrative only and is not intended to be in any way limiting. In addition to the illustrative aspects, embodiments, and features described above, further aspects, embodiments, and features will become apparent by criterion to the drawings and the following detailed description.

### BRIEF DESCRIPTION OF THE DRAWINGS

FIG. 1 is a block diagram schematically illustrating a device for determining a separation criterion of a sound source according to an exemplary embodiment of the present invention.

FIGS. 2A and 2B is a block diagram specifically illustrating an internal configuration of the device for determining a separation criterion of a sound source according to the exemplary embodiment of the present invention.

FIG. 3 is a block diagram schematically illustrating an apparatus for separating a sound source according to an exemplary embodiment of the present invention.

FIGS. 4A and 4B is a block diagram specifically illustrating an internal configuration of the apparatus for separating a sound source according to the exemplary embodiment of the present invention.

FIG. 5 is an exemplary diagram of the apparatus for separating a sound source according to the exemplary embodiment of the present invention.

FIGS. 6A and 6B is graphs illustrating examples of an approximation transfer function of an Inter-aural Time Delay and an Inter-aural Intensity Difference of a signal according to a horizontal angle of a sound source, respectively.

FIG. 7 is a diagram illustrating an example of a horizontal angle histogram.

FIG. 8 is a flowchart illustrating a method of determining a separation criterion of a sound source according to an exemplary embodiment of the present invention.

FIG. 9 is a flowchart illustrating a method of separating a sound source according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, criterion numbers refer to the same or equivalent parts of the present invention throughout the several figures of the drawing.

### DETAILED DESCRIPTION

Hereinafter, exemplary embodiments of the present invention will be described in detail with reference to the accompanying drawings. First of all, we should note that in giving reference numerals to elements of each drawing, like reference numerals refer to like elements even though like elements are shown in different drawings. In describing the present invention, well-known functions or constructions will not be described in detail since they may unnecessarily obscure the understanding of the present invention. It should be understood that although exemplary embodiment of the present invention are described hereafter, the spirit of the present invention is not limited thereto and may be changed and modified in various ways by those skilled in the art.

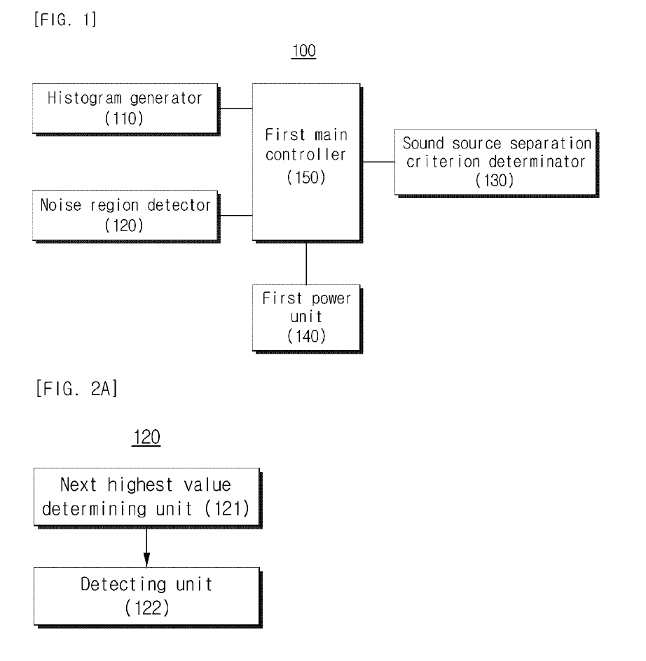

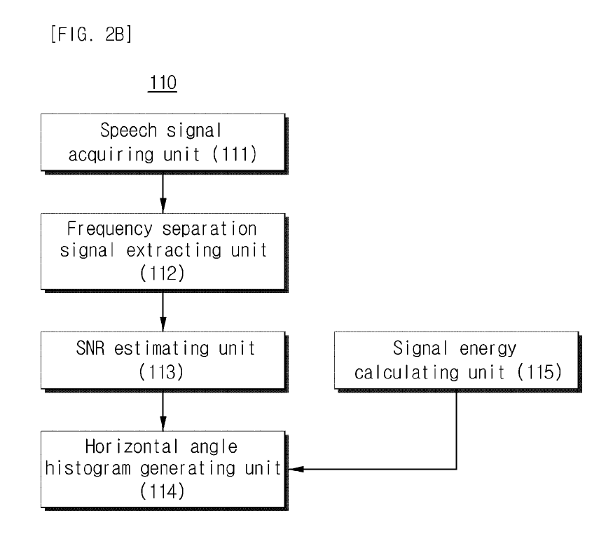

FIG. 1 is a block diagram schematically illustrating a device for determining a separation criterion of a sound source according to an exemplary embodiment of the present invention. FIGS. 2A and 2B is a block diagram specifically illustrating an internal configuration of the device for determining a separation criterion of a sound source according to the exemplary embodiment of the present invention. Hereinafter, the device for determining a separation criterion of a sound source will be described with reference to FIGS. 1 to 2B.

Referring to FIG. 1, the device 100 for determining a separation criterion of a sound source includes a histogram generator 110, a noise region detector 120, a sound source separation criterion determinator 130, a first power unit 140, and a first main controller 150.

The histogram generator 110 functions to generate a histogram associated with a directionality of a sound source included in an input signal based on an SNR obtained from the input signal or an energy value of the input signal. The histogram generator 110 generates the histogram using a multiplication value of the SNR and the energy value as a weight value. As shown in FIG. 2B, the histogram generator 110 may include a speech signal acquiring unit 111, a frequency separation signal extracting unit 112, an SNR estimating unit 113, and a horizontal angle histogram generating unit 114. The histogram generator 110 may further include a signal energy calculating unit 115. The speech signal acquiring unit 111 functions to acquire a speech signal as the input signal. The frequency separation signal extracting unit 112 functions to frequency-separate the acquired speech signal to extract channel signals. The SNR extracting unit 113 functions to estimate the SNR from the extracted channel signals. The horizontal angle histogram generating unit 114 functions to generate a horizontal angle histogram as the histogram and use an SNR estimated when generating the horizontal angle histogram. The SNR estimating unit 113 may estimate an SNR using an Inter-aural Time Delay (ITD) value obtained in a zero-crossing point of the extracted channel signal. For example, the SNR estimating unit 113 may estimate the SNR using variance of the ITD value to more exactly obtain an orientation of a sound source. The signal energy calculating unit 115 functions to calculate a signal energy value to be used for generating the histogram using an Inter-aural Intensity Difference (IID) acquired in at least one zero-crossing section adjacent to a zero-crossing point.

The noise region detector 120 functions to detect a noise region from an input signal using the highest value in the generated histogram as a region value of a target sound source. The noise region detector 120 detects a noise region based on at least one next highest value located at a left side or a right side of the highest value. As shown in FIG. 2A, the noise region detector 120 may include a next highest value determining unit 121 and a detecting unit 122. The next highest value determining unit 121 functions to determine whether a next highest value from a multiplication value of a threshold and the highest value to an absolute value of the highest value is located at a left side or a right side of the highest value. If the next highest value is located at the left side or the right side of the highest value, the detecting unit 122 functions to detect a noise region based on the next highest value. If the next highest value is not located at the left side or the right side of the highest value, the detecting unit 122 functions to detect the noise region in consideration of an orientation of the target sound source based on the highest value.

The sound source separation criterion determinator 130 functions to determine a boundary value between the target sound source and the detected noise region as a criterion value for separating the sound source. The sound source separation criterion determinator 130 determines an intermediated value of the highest value and the next highest value as the criterion value.

The first power unit 140 functions to supply power to respective constituent elements constructing the device 100 for determining a separation criterion of a sound source. The first main controller 150 functions to control an overall operation of respective constituent elements constructing the device 100 for determining a separation criterion of a sound source.

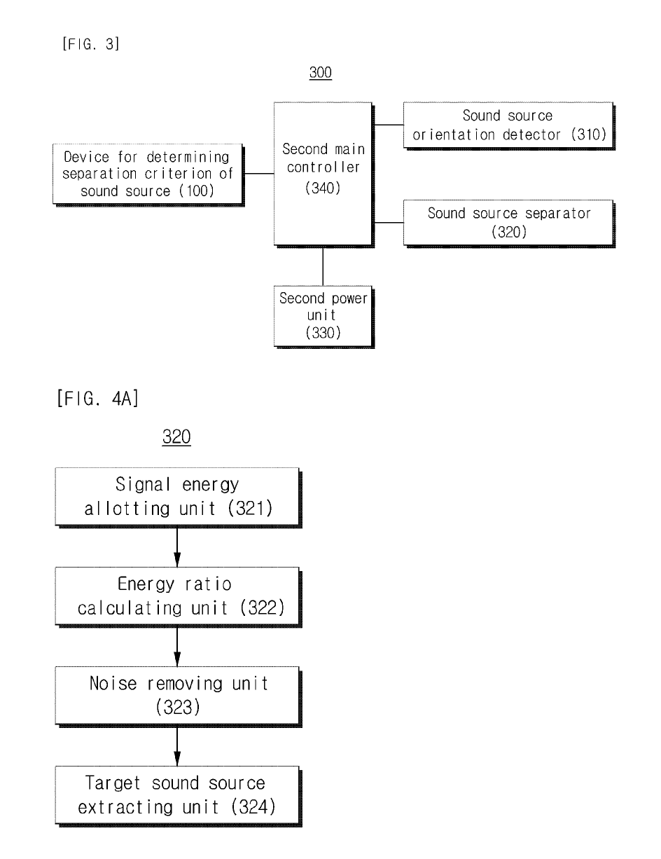

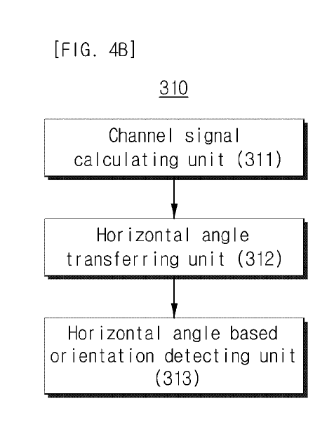

FIG. 3 is a block diagram schematically illustrating an apparatus for separating a sound source according to an exemplary embodiment of the present invention. FIGS. 4A and 4B is a block diagram specifically illustrating an internal configuration of the apparatus for separating a sound source according to the exemplary embodiment of the present invention. Hereinafter, the apparatus for separating a sound source will be described with reference to FIGS. 3 to 4B.

Referring to FIG. 3, an apparatus 300 for separating a sound source includes a device 100 for determining a separation criterion of a sound source, a sound source orientation detector 310, a sound source separator 320, a second power unit 330, and a second main controller 340.

The sound source orientation detector 310 functions to detect an orientation of a sound source included in an input signal using a signal-to-noise ratio associated with an ITD of the input signal or an energy value associated with an IID of the input signal. As shown in FIG. 4B, the sound source orientation detector 310 may include a channel signal calculating unit 311, a horizontal angle transferring unit 312, and a horizontal angle based orientation detecting unit 313. The channel signal calculating unit 311 functions to calculate the ITD and the IID for each channel signal obtained by frequency-separating the input signal. The horizontal angle transferring unit 312 functions to transfer the ITD and the IID obtained through the calculation into horizontal angles, respectively. The horizontal angle based orientation detecting unit 313 functions to detect an orientation of the sound source by one horizontal angle acquired when a difference between the two transferred horizontal angles has the smallest value.

The device 100 for determining a separation criterion of a sound source is a device for determining a criterion value for separating a sound source based on an SNR or an energy value, and may include a histogram generator, a noise region detector, and a sound source separation criterion determinator. The histogram generator functions to generate a histogram associated with orientation of a sound source based on an SNR or an energy value. The noise region detector functions to detect a noise region from an input signal using a highest value in the generated histogram as a region value of a target sound source. The sound source separation criterion determinator functions to determine a boundary value between the target sound source and the detected noise region as a criterion value for separating the sound source. The device 100 for determining a separation criterion of a sound source may further include configurations described in FIGS. 1 to 2B in addition to the aforementioned configuration.

The sound source separator 320 functions to separate the input signal into the target sound source and the noise based on the criterion value. As shown in FIG. 4A, the sound source separator 320 may include a signal energy allotting unit 321, an energy ratio calculating unit 322, a noise removing unit 323, and a target sound source extracting unit 324. The signal energy allotting unit 321 functions to allot an energy value associated with a highest value in a corresponding region for each division region divided from the input signal. The energy ratio calculating unit 322 functions to calculate an allotted energy ratio between the target sound source and the detected noise region based on the criterion value. The noise removing unit 323 functions to remove the noise from the input signal based on the allotted energy ratio. The target sound source extracting unit 324 functions to extract the target sound source for the input signal from which the noise is removed.

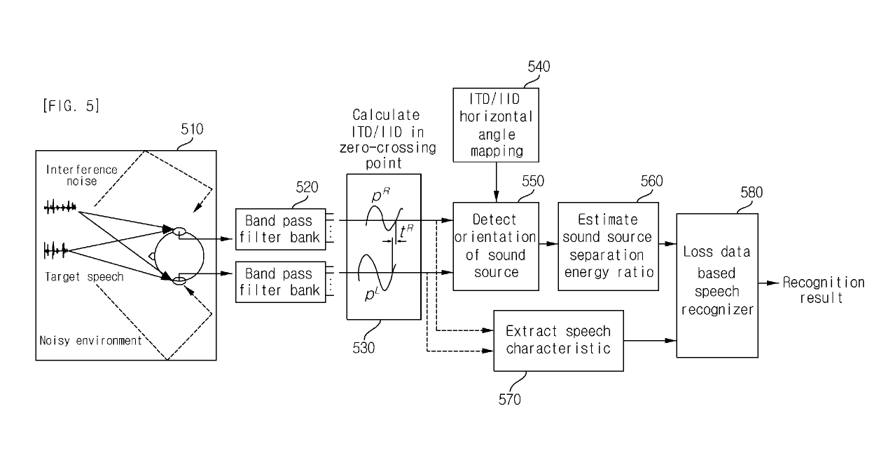

Hereinafter, an exemplary embodiment of an apparatus for separating a sound source of FIG. 3 will be explained. FIG. 5 is an exemplary diagram of an apparatus for separating a sound source according to the exemplary embodiment of the present invention, and is a block diagram illustrating an internal configuration of the apparatus for separating a sound source using a zero-crossing point in a noisy environment. Hereinafter, the apparatus for separating a sound source will be described with reference to FIG. 5.

The present invention allows a human to recognize a location of a sound source in a three-dimensional space using two ears and applies a method of separating a sound source in a certain orientation to improve the performance of an application technology using a speech in a noisy environment. The present invention acquires a speech signal using two sensors and determines an orientation angle of a sound source in a zero-crossing point step with respect to a frequency separated signal with a band pass filter bank. An object of the present invention is to obtain excellent sound source orientation detection and division performance, which is not easily obtained in a crossing correlation method calculated in units of existing time frames in a noisy environment with a plurality of sound sources.

An ITD being representative orientation information measured using two sensors is available in a low frequency channel, but becomes severely ambiguous due to a short wavelength of a signal in a high frequency channel and thus it is difficult to use the ITD. The present invention converts ITD and IID into horizontal angle regions, and determines a horizontal angle having the smallest difference as an orientation of a sound source using an aspect that ITD information and IID information are complementary with respect to orientation information of a sound source to each other. This method is equally applied to a low frequency channel and a high frequency channel to prevent ambiguity of the ITD information in a high frequency channel from occurring.

When there are a plurality of sound sources in a space, so as to separate a target speech of a certain orientation and a peripheral interference noise, a boundary value with respect to an orientation needs to be set. In the present invention, a remarkable sound source is searched from a horizontal angle histogram using a multiplication value of an estimated value of an SNR of a channel signal and an energy value of a zero-crossing section as a weight value, and a boundary value for separating a sound source is set according to a target sound source and an orientation of a peripheral sound source.

A technology of separating a target speech and an interference noise in a feature space of a time-frequency domain is an important technology for performing more robust speech recognition in various noisy environments. Because most existing technologies of separating a sound source according to an orientation of the sound source using two sensors determines an orientation of a sound source for each time frame, it is not easy to estimate a mixed ratio of an interference noise with a target speech. Thus, the present invention suggests a method of obtaining orientation information of a sound source based on an ITD and an IID obtained from a zero-crossing point of a signal for more delicate calculation and obtaining an energy ratio for separating a target speech and an interference noise in a time-frequency domain.

A method of determining an orientation of a sound source in a zero-crossing point of a frequency separated signal according to the present invention includes frequency-separating signals received from two sensors for each channel using a band pass filter bank; obtaining an ITD and an IID of the signals generated from the two sensors in an upper zero-crossing point of the frequency separated signals for each channel; and transferring the obtained ITD and the IID into horizontal angles, respectively, and determining a horizontal angle having the smallest difference in a corresponding zero-crossing point as the orientation of the sound source.

A method of determining a boundary value of a horizontal angle to separate a frequency separated signal into a target speech and an interference noise according to the present invention, includes: determining an orientation of a sound source in a zero-crossing point of the frequency separated signal by a sound source orientation determining method; estimating an SNR in a zero-crossing point of the frequency separated signal; generating a horizontal angle histogram using a multiplication value of an estimated value of the SNR and an energy value of an adjacent zero-crossing section as a weight value; searching a highest value of a target speech orientation from the horizontal angle histogram and searching an orientation of a remarkable interference noise in left and right orientations based on the searched highest value; and determining a center location of the target speech and the interference noise in the horizontal angle histogram as a boundary value for separating the sound source.

A method of acquiring an energy ratio of a target speech to an interference noise for each time-frequency domain from a signal having a plurality of mixed sound sources to separate the target speech and the interference noise according to the present invention, includes: determining an orientation of a sound source in a zero-crossing point of a frequency separated signal; determining a horizontal angle boundary value to discriminate a target speech and an interference noise; allotting an energy value adjacent to corresponding zero-crossing to an energy value of the target speech or the interference noise according to a horizontal angle in a zero-crossing point for each time-frequency domain; and calculating a ratio of the energy value of the target speech to the energy value of the interference noise for each time-frequency domain.

Hereinafter, the method of determining an orientation of a sound source in a zero-crossing point and a method of separating a target speech and an interference noise using orientation information of a sound source in a time-frequency domain to obtain an energy ratio according to the present invention will be described in detail as follows.

Speech signals generated from two sensors are frequency-separated through respective band pass filters to obtain channel signals xᵢ^{L}(t) and xᵢ^{R}(t), respectively (510 and 520). Here, the i indicates a frequency channel number, and the L and the R indicate sensors, respectively.

Extraction of Orientation Information (530)

There are an ITD and an IID as representative orientation information generated in a three-dimensional space according to a location of a sound source. Two types of orientation information in a zero-crossing point of a channel signal are defined by the following equation.

$$\begin{matrix}ITD = Δ {t}_{i} ( n , m ) = {t}_{i}^{L} ( n ) - {t}_{i}^{R} ( m ) & [ Equation 1 ] \\ IID = Δ {p}_{i} ( n , m ) = 10 {log}_{10} \frac{{p}_{i}^{L} ( n )}{{p}_{i}^{R} ( m )} & [ Equation 2 ]\end{matrix}$$

In Equations 1 and 2, the n and the m indicate upper zero-crossing point numbers of a frequency channel signal by sensors. The tᵢ^{L}(n) and the tᵢ^{R}(m) indicate upper zero-crossing point times of respective channel signals, and the pᵢ^{L}(n) and the pᵢ^{R}(m) indicate average energy values of a signal in a section between upper zero-crossing points, respectively. For example, the pᵢ^{L}(n) indicates an average energy value of a signal between time intervals periods tᵢ^{L}(n−1) and tᵢ^{L}(n).

In Equations 1 to 2, orientation information of the ITD and the IID are defined between zero-crossing points of frequency separated channel signals provided from two sensors. In this case, a pair of zero-crossing points matching with an orientation of a sound source needs to be selected from a plurality of corresponding zero-crossing points. To this end, so as to select an m-th zero-crossing point of an R sensor side corresponding to an n-th zero-crossing point of an L sensor as illustrated in Equation 3, the ITD value and the IID value are transferred to corresponding horizontal angles, respectively, a horizontal angle at which the difference is the smallest value is determined as an orientation of a sound source in a zero-crossing point, and a pair of zero-crossing points in this case is selected as a zero-crossing point matching with the orientation of the sound source.

$$m = {argmin}_{k} \vert {θ}_{ITD} ( n , k ) - {θ}_{IID} ( n , k ) \vert \qquad [ Equation 3 ]$$

In Equation 3, a pair of zero-crossing points having the horizontal angle best matching with the orientation of the sound source is determined. Among horizontal angles corresponding to the ITD value and the IID value, a horizontal angle transfer value of the ITD value having a relatively great discrimination power is determined as a horizontal angle in a corresponding zero-crossing point as illustrated in Equation 4.

θᵢ(n)=θ_{ITD}(n,m) [Equation 4]

Transfer Function of Orientation Information and Horizontal Angle (540)

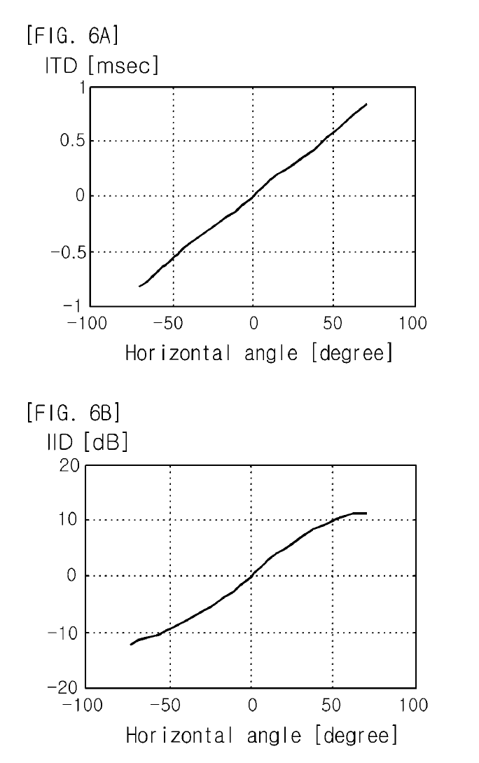

In the present invention, an ITD value and an IID value obtained in a zero-crossing point are transferred into horizontal angles to determine an orientation of a sound source. The transfer function indicates generation degrees of an ITD and an IID according to paths to which the sound source arrives at two sensors, respectively. Head-related transfer function (HRTF) measured in two ears of a man has different shapes of a transfer function for each frequency channel and non-linear characteristics. However, when the two sensors are located on a plane and obstacles on a transfer path of a sound wave are relatively simple, the HRTF may approximate to a form of a simple increasing function. FIGS. 6A and 6B shows graphs illustrating examples of an approximation transfer function of the ITD and the IID of a signal according to a horizontal angle of a sound source, respectively. FIG. 6A illustrates a transfer function between an approximated ITD and a horizontal angle, and FIG. 6B illustrates a transfer function between an approximated IID and a horizontal angle.

Equation 5 expresses a transfer function f_{T} between the ITD value and the horizontal angle.

θ_{ITD}(n,m)=ƒ_{T}⁻¹(Δtᵢ(n,m)) [Equation 5]

Equation 6 expresses a transfer function f_{I} between the IID value and the horizontal angle.

θ_{IID}(n,m)=ƒ_{I}⁻¹(Δpᵢ(n,m)) [Equation 6]

Detection of Orientation of Sound Source (550)

An SNR by frequency channels is estimated using a variance value of an ITD sample according to a method of detecting an orientation using a zero-crossing point as illustrated in Equation 7.

$${SNR}_{i} ( n ) = 10 {log}_{10} \frac{1}{{w}_{i}^{2} Var ( {t}_{i} ( n , m ) )} \qquad [ Equation 7 ]$$

In Equation 7, the i indicates a frequency channel number, and the n and the m indicate zero-crossing point numbers of a frequency channel, respectively. The wᵢ indicates a center frequency of a channel, and the Var(Δtᵢ(n,m)) indicates a variance value of an ITD value in a zero-crossing point.

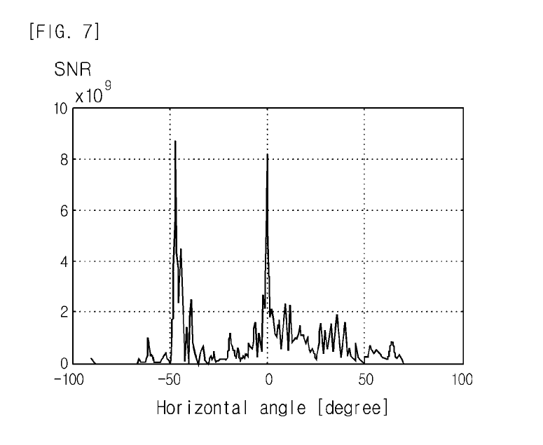

So as to detect an orientation of the sound source, the present invention obtains a horizontal angle θᵢ(n) by channels in a zero-crossing point and accumulates, in a horizontal angle histogram h(θ), a weight value ξᵢ(n) obtained by multiplying an SNR, SNRᵢ(n) obtained in a corresponding zero-crossing point by a section energy value pᵢ(n). This weight value functions to remarkably emphasize a sound source in which an SNR of a signal is high and an energy value is relatively greater in a horizontal angle histogram. The horizontal angle histogram is obtained by accumulating the weight value in all zero-crossing points of all frequency channels in entire sections with a speech. FIG. 7 is one example of the obtained horizontal angle histogram, and indicates a case where two sound sources are situated around horizontal angle 0 degree and horizontal angle −50 degrees in a noisy environment, respectively.

ξᵢ(n)=SNRᵢ(n)·pᵢ(n) [Equation 8]

Separation of Sound Source in Time-Frequency Domain (560 and 570)

The present invention determines a boundary value of a horizontal angle separating a target speech and an interference noise so as to separate a signal into the target speech and the interference noise using orientation information in a zero-crossing point as shown in the following algorithm. In this case, it is assumed that a user has previously known an orientation θ_{T0} of a target speech.

A boundary value determining algorithm 570 for separating a sound source is as follows.

First, a highest value h_{T0}(θ_{T0}) of an orientation of a target speech is searched from a weight horizontal angle histogram.

Next, so as to detect orientations of a target speech and an adjacent interference sound source, the highest value whose adjacent size is greater than TH(threshold)·h_{T0} within θ_{MAX} of an absolute value is searched from a left direction and a right direction in a horizontal angle of a target speech. In this case, the highest value searched in a left orientation and the highest value searched in a right orientation are expressed as h_{IL}(θ_{IL}) and h_{IR}(θ_{IR}), respectively. When the highest value is not detected in an adjacent orientation, θ_{MAX} is regarded as an orientation of the adjacent interference sound source.

Subsequently, a horizontal angle boundary value discriminating the target speech and the interference noise is determined as an intermediate value of a horizontal angle of the target speech and a horizontal angle of an adjacent sound source as illustrated in Equations 9 and 10.

$$\begin{matrix}{θ}_{BL} = \frac{{θ}_{TO} + {θ}_{IL}}{2} & [ Equation 9 ] \\ {θ}_{BR} = \frac{{θ}_{TO} + {θ}_{IR}}{2} & [ Equation 10 ]\end{matrix}$$

An energy ratio in a time-frequency domain for separating a target speech and the interference noise is obtained as follows. An energy ratio calculating algorithm 560 for separating a sound source is as follows.

First of all, an energy value p_{T}(τ,i) of a target sound source and an energy value p_{I}(τ,i) of an interference noise with respect to all zero-crossing points in a time-frequency domain are calculated as follows. First, when a horizontal angle θ(n) obtained in an n-th zero-crossing point is located in a sound source separation boundary value, that is, when θ_{BL}≦θ(n)≦θ_{BR}, a section energy p(n) of a corresponding zero-crossing point is added to a target sound source energy p_{T}(τ,i). Second, when the horizontal angle θ(n) obtained in an n-th zero-crossing point is located beyond a sound source separation boundary value, a section energy p(n) of a corresponding zero-crossing point is added to an interference noise energy p_{I}(τ,i).

Next, an energy ratio r(τ,i) in a time-frequency domain is obtained as illustrated in Equation 11. In Equation 11, the τ is a time frame number, and the i is a frequency channel number.

$$r ( τ , i ) = \frac{{p}_{T} ( τ , i )}{{p}_{T} ( τ , i ) + {p}_{I} ( τ , i )} \qquad [ Equation 11 ]$$

If a loss data based speech recognizer 580 is used after performing the aforementioned two algorithms, a sound source in which a noise is removed from an input signal may be extracted.

The present invention acquires a speech signal using two sensors and determines an orientation angle of a sound source in a zero-crossing point with respect to a band pass filter bank signal. Excellent sound source orientation detection and separation performance can be obtained which is not easily achieved in an existing crossing correlation method calculated in units of time frames in a noisy environment having a plurality of sound sources.

In an existing method of detecting an orientation using two sensors, time delay information of a signal is predominantly used in a low frequency channel, and intensity difference information is predominantly used in a high frequency channel. However, a method for detecting an orientation using a zero-crossing point according to the present invention simultaneously use time delay information and intensity difference information of signals generated by two sensors and has an advantage of detecting orientation information regardless of a frequency channel.

The present invention obtains an energy ratio of a target speech and an interference noise which cannot be obtained by an existing method in a time-frequency domain for separating a sound source. A horizontal angle region in a fixed range for separating a sound source is not used, and the range thereof is dynamically determined as an orientation of the sound source is changed, which is more valuable when applied to an actual application.

The present invention relates to a method of separating signals received from two sensors for each frequency by a band pass filter bank, determining an orientation of a sound source using time delay and intensity difference information of a signal measured in a zero-crossing point, and obtaining an energy ratio separating a signal into a target speech and an interference noise according to the orientation of the sound source in a time-frequency domain.

The present invention expands the invention relating to detection of an orientation of a sound source using a zero-crossing point, and transfers an ITD and an IID of a signal measured in a zero-crossing point into horizontal angle regions, respectively, to determine a horizontal angle having the smallest difference as an orientation of the signal. This method may more exactly detect an orientation of a sound source in not only a low frequency channel but a high frequency channel in an actual environment in which a noise is present.

The present invention suggests a method of automatically determining a boundary value of a horizontal angle region for separating a target speech and an interference noise using orientation information of the sound source, and a method of distinguishing a section energy value in each zero-crossing point into a target speech and an interference noise based on the obtained boundary value and obtaining an energy ratio separating the target speech and the interference noise in a time-frequency domain. The obtained energy ratio in a time-frequency domain may be used as an SNR in the time-frequency domain for removing a noise through separation of the sound source and speech recognition of loss data.

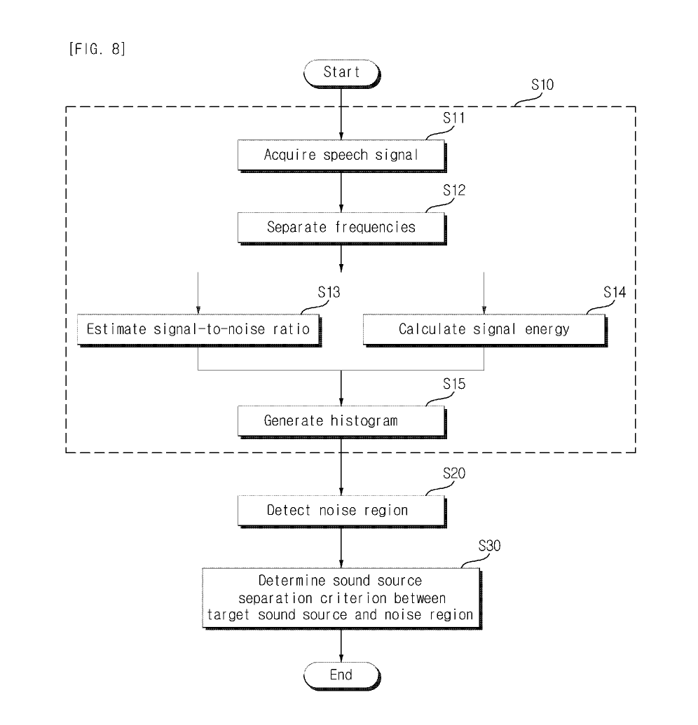

FIG. 8 is a flowchart illustrating a method of determining a separation criterion of a sound source according to an exemplary embodiment of the present invention. Hereinafter, the method of determining a separation criterion of a sound source will be described with reference to FIGS. 1, 2A, 2B, and 8.

First, a histogram generator 110 generates a histogram associated with a directionality of a sound source included in an input signal based on an SNR obtained from the input signal or an energy value of the input signal (histogram generating step S10). The histogram generator 110 generates the histogram using a multiplication value of the SNR and the energy value as a weight value. The histogram generating step S10 includes: acquiring a speech signal as an input signal by a speech signal acquiring unit 111 (S11); frequency-separating the acquired speech signal to extract channel signals by a frequency separating signal extracting unit 112 (S12); estimating an SNR from the extracted channel signals by an SNR estimating unit 113 (S13); and generating a horizontal angle histogram as the histogram and using an SNR estimated when generating the horizontal angle histogram by a horizontal angle histogram generating unit 114 (S15). The SNR estimating unit 113 may estimate an SNR using an ITD obtained in a zero-crossing point of the extracted channel signals. The histogram generating step S10 may further include calculating an energy value to be used to generate the histogram using an IID obtained in at least one zero-crossing section adjacent to the zero-crossing point by a signal energy calculating unit 115 (S14).

After the histogram generation step S10, a noise region detector 120 detects the noise region from the input signal using a highest value in the generated histogram as a region value of the target sound source (noise region detecting step S20). The noise region detector 120 detects the noise region based on at least one next highest value located at a left side or right side of the highest value. The noise region detecting step S20 includes: determining whether a next highest value from a multiplication value of a threshold and the highest value to an absolute value of the highest value is located at the left side or the right side of the highest value by a next highest value determining unit 121; and detecting a noise region based on the next highest value by a detecting unit 122 if the next highest value is located, and detecting the noise region in consideration of an directionality of a target sound source based on the highest value by the detecting unit 122 if the next highest value is not located.

After the noise region detecting step S20, a sound source separation criterion determinator 130 determines a boundary value between a target sound source and the detected noise region as a criterion value for separating the sound source (sound source separation criterion determining step S30). The sound source separation criterion determinator 130 determines an intermediate value of the highest value and a next highest value as a criterion value.

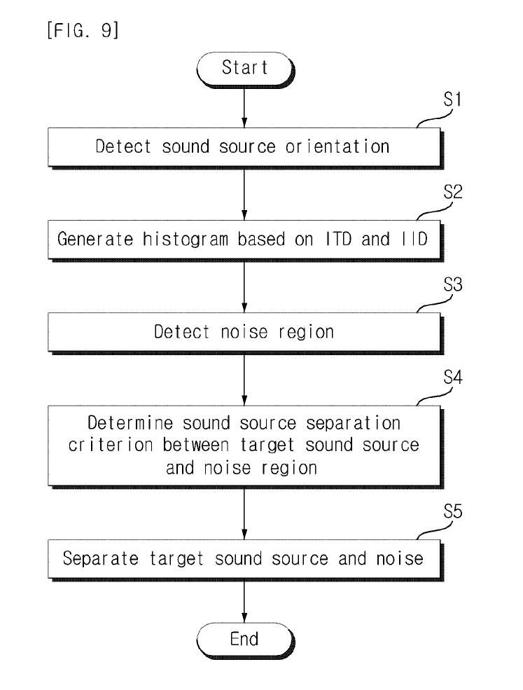

FIG. 9 is a flowchart illustrating a method of separating a sound source according to an exemplary embodiment of the present invention. Hereinafter, the method of separating a sound source according to the present invention will be described with reference to FIGS. 3, 4A, 4B, and 9.

First, the sound source orientation detector 310 detects an orientation of a sound source included in an input signal using an SNR associated with an ITD of the input signal or an energy value associated with an IID of the input signal (sound source orientation detecting step S1). The sound source orientation detecting step S1 includes: calculating an ITD and an IID for each channel signal obtained by frequency-separating the input signal by a channel signal calculating unit 311; transferring the ITD and the IID obtained through the calculation into horizontal angles, respectively, by a horizontal angle transferring unit 312; and detecting an orientation of the sound source by one horizontal angle acquired when a difference between the two transferred horizontal angles has the smallest value by a horizontal angle based orientation detecting unit 313.

After the sound source orientation detecting step S1, the device 100 for determining a separation criterion of a sound source generates a histogram associated with a directionality of the sound source based on the SNR or the energy value (histogram generating step S2).

After the histogram generating step S2, the device 100 for determining a separation criterion of a sound source detects a noise region from an input signal using the highest value in the generated histogram as a region value of the target sound source (noise region detecting step S3).

After the noise region detecting step S3, the device 100 for determining a separation criterion of a sound source determines a boundary value between the target sound source and the detected noise region as a criterion value for separating a sound source (sound source separation criterion determining step S4).

After the sound source separation criterion determining step S4, the sound source separator 320 separates an input signal into a target sound source and a noise based on the criterion value (sound source separating step S5). The sound source separating step S5 includes: allotting an energy value associated with a highest value in a corresponding region for each division region divided from the input signal by a signal energy allotting unit 321; calculating an allotted energy ratio between the target sound source and the detected noise region based on a criterion value by an energy ratio calculating unit 322; removing the noise from the input signal based on the allotted energy ratio by a noise removing unit 323; and extracting the target sound source from the input signal from which the noise is removed by a target sound source extracting unit 324.

The aforementioned sound source separating method is summarized as follows.

First, the present invention suggests a method of acquiring a speech signal using two sensors to determine an orientation angle of a sound source in a zero-crossing point with respect to a frequency separated channel signal by a band pass filter bank, that is, a method of transferring an ITD and an IID obtained in a zero-crossing point into a horizontal angle, respectively, as illustrated in Equation 3 to determine a horizontal angle obtained from a pair of zero-crossing points having the smallest value as an orientation of the sound source in a zero-crossing point.

Secondly, the present invention suggests a method of obtaining an orientation of the sound source in a zero-crossing point of all frequency channels in the firstly suggested method, obtaining an SNR of a channel in a method of Equation 7, obtaining a horizontal angle histogram using a multiplication value of a section energy value of the zero-crossing point and the SNR as a weight value, obtaining a horizontal angle histogram using the section energy value in the zero-crossing point and the SNR as the weight as illustrated in Equation 8, and determining an orientation of the highest value in the obtained horizontal angle histogram as an orientation of the sound source.

Third, the present invention suggests a method of determining a boundary value separating a target speech and an interference noise when an orientation of the target speech is known in an environment having a plurality of sound sources, namely, a method of searching a highest value of an orientation of a target speech in a weight horizontal angle histogram obtained in the second method as illustrated in a boundary value determining algorithm for separating a sound source, searching the highest value of a left orientation and the highest value of a right orientation with an adjacent interference sound source based on the highest value, and determining an intermediate value of the target speech and the interference noise as a boundary value for separating the sound source as shown in Equations 9 and 10.

Fourthly, the present invention suggests a method of separating a target speech and an interference noise using a zero-crossing point in a time-frequency domain, namely, a method of determining an orientation of a sound source with respect to all zero-crossing points included in the time-frequency domain by the first suggested method as illustrated in an energy ratio calculating algorithm for separating the sound source, adding a zero-crossing point section energy to a target sound source energy when an orientation of the sound source is close to the target sound source according to a sound source separation boundary value determined by the thirdly suggested method, and otherwise, obtaining an energy ratio separating a target speech and an interference noise of a time-frequency domain after adding the zero-crossing point section energy to an interference noise energy, as illustrated in Equation 11.

Fifthly, the present invention suggests a method of expressing a difference of a zero-crossing time in a channel signal reaching two sensors in the form of a transfer function between the ITD value and the horizontal angle as illustrated in Equation 5, which is used for determining an orientation of the sound source using a zero-crossing point.

Sixthly, the present invention suggest a method of expressing an energy difference of a zero-crossing point section in a channel signal reaching two sensors in the form of the transfer function with respect to an orientation of the sound source as illustrated in Equation 6, which is used for determining an orientation of the sound source using a zero-crossing point.

The device and the method for determining a separation criterion of a sound source and the apparatus and the method for separating a sound source are applicable to a portable automatic Korean/English interpretation technology field.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A device for determining a separation criterion of a sound source, the device comprising:
a histogram generator generating a histogram associated with a directionality of a sound source included in an input signal based on a signal-to-noise ratio obtained from the input signal or an energy value of the input signal;
a noise region detector detecting a noise region from the input signal using a highest value in the generated histogram as a region value of a target sound source; and
a sound source separation criterion determinator determining a boundary value between the target sound source and the detected noise region as a criterion value for separating the sound source.

2. The device of claim 1, wherein the noise region detector detects the noise region based on at least one next highest value located at a left side or a right side of the highest value.

3. The device of claim 2, wherein the noise region detector includes:
a next highest value determining unit determining whether a next highest value not less than a multiplication value of a threshold and the highest value and not greater than an absolute value of the highest value is located at the left side or the right side; and
a detecting unit detecting the noise region based on the next highest value when the next highest value is located, and detecting the noise region in consideration of an directionality of the target sound source based on the highest value when the next highest value is not located.

4. The device of claim 2, wherein the sound source separation criterion determinator determines an intermediated value of the highest value and the next highest value as the criterion value.

5. The device of claim 1, wherein the histogram generator includes:
a speech signal acquiring unit acquiring a speech signal as the input signal;
a frequency separation signal extracting unit frequency-separating the acquired speech signal to extract channel signals;
a signal-to-noise ratio estimating unit estimating the signal-to-noise ratio from the extracted channel signals; and
a horizontal angle histogram generating unit generating a horizontal angle histogram and using a signal-to-noise ratio estimated when generating the horizontal angle histogram.

6. The device of claim 5, wherein the signal-to-noise ratio estimating unit estimates the signal-to-noise ratio using an Inter-aural Time Delay (ITD) value obtained in a zero-crossing point of the extracted channel signal, and
the histogram generator further includes a signal energy calculating unit calculating the energy value to be used for generating the histogram using an Inter-aural Intensity Difference (IID) acquired in at least one zero-crossing section adjacent to the zero-crossing point.

7. The device of claim 1, wherein the histogram generator generates the histogram using a multiplication value of the signal-to-noise ratio and the energy value as a weight value.

8. A method for determining a separation criterion of a sound source, the method comprising:
generating a histogram associated with an directionality of a sound source included in an input signal based on a signal-to-noise ratio obtained from the input signal or an energy value of the input signal;
detecting a noise region from the input signal using a highest value in the generated histogram as a region value of a target sound source; and
determining a boundary value between the target sound source and the detected noise region as a criterion value for separating the sound source.

9. The method of claim 8, wherein the detecting of a noise region includes detecting the noise region based on at least one next highest value located at a left side or a right side of the highest value.

10. The method of claim 9, wherein the detecting of a noise region includes:
determining whether a next highest value not less than a multiplication value of a threshold and the highest value and not greater than an absolute value of the highest value is located at the left side or the right side; and
detecting the noise region based on the next highest value when the next highest value is located, and detecting the noise region in consideration of an directionality of the target sound source based on the highest value when the next highest value is not located.

11. The method of claim 8, wherein the generating of a histogram includes:
acquiring a speech signal as the input signal;
frequency-separating the acquired speech signal to extract channel signals;
estimating the signal-to-noise ratio from the extracted channel signals; and
generating a horizontal angle histogram and using a signal-to-noise ratio estimated when generating the horizontal angle histogram.

12. The method of claim 11, wherein the estimating of the signal-to-noise ratio includes estimating the signal-to-noise ratio using an Inter-aural Time Delay (ITD) value obtained in a zero-crossing point of the extracted channel signal, and
the generating of the histogram further includes calculating the energy value to be used for generating the histogram using an Inter-aural Intensity Difference (IID) acquired in at least one zero-crossing section adjacent to a zero-crossing point.

13. An apparatus for separating a sound source, the apparatus comprising:
a sound source orientation detector detecting an orientation of a sound source included in an input signal using a signal-to-noise ratio associated with an Inter-aural Time Delay (ITD) of the input signal or an energy value associated with an Inter-aural Intensity Difference (IID) of the input signal;
a histogram generator generating a histogram associated with orientation of a sound source based on the SNR and the energy value;
a noise region detector detecting a noise region from the input signal using a highest value in the generated histogram as a region value of a target sound source;
a sound source separation criterion determinator determining a boundary value between the target sound source and the detected noise region as a criterion value for separating the sound source; and
a sound source separator separating the input signal into the target sound source and the noise based on the criterion value.

14. The apparatus of claim 13, wherein the sound source separator includes:
a signal energy allotting unit allotting an energy value associated with the highest value in a corresponding region for each division region divided from the input signal;
an energy ratio calculating unit calculating an allotted energy ratio between the target sound source and the detected noise region based on the criterion value;
a noise removing unit removing the noise from the input signal based on the allotted energy ratio; and
a target sound source extracting unit extracting the target sound source for the input signal from which the noise is removed.

15. The apparatus of claim 13, wherein the sound source orientation detector includes:
a channel signal calculating unit calculating the ITD and the IID for each channel signal obtained by frequency-separating the input signal;
a horizontal angle transferring unit transferring the ITD and the IID obtained through the calculation into horizontal angles, respectively; and
a horizontal angle based orientation detecting unit detecting an orientation of the sound source by one horizontal angle acquired when a difference between the two transferred horizontal angles has the smallest value.

16. A method for separating a sound source, the method comprising:
detecting an orientation of a sound source included in an input signal using a signal-to-noise ratio associated with an Inter-aural Time Delay (ITD) of the input signal or an energy value associated with an Inter-aural Intensity Difference (IID) of the input signal;
generating a histogram associated with a directionality of the sound source based on an signal-to-noise ratio or an energy value;
detecting a noise region from the input signal using a highest value in the generated histogram as a region value of a target sound source;
determining a boundary value between the target sound source and the detected noise region as a criterion value for separating the sound source; and
separating the input signal into the target sound source and the noise based on the criterion value.

17. The method of claim 16, wherein the separating of the input signal includes:
allotting an energy value associated with a highest value in a corresponding region for each division region divided from the input signal;
calculating an allotted energy ratio between the target sound source and the detected noise region based on the criterion value;
removing the noise from the input signal based on the allotted energy ratio; and
extracting the target sound source for the input signal from which the noise is removed.

18. The method of claim 16, wherein the detecting of an orientation of a sound source includes:
calculating the ITD and the IID for each channel signal obtained by frequency-separating the input signal;
transferring the ITD and the IID obtained through the calculation into horizontal angles, respectively; and
detecting an orientation of the sound source by one horizontal angle acquired when a difference between the two transferred horizontal angles has the smallest value.
